(19) United States
(12) Patent Application Publication
(10) Pub. No.: US 2018/0261102 A1
(43) Pub. Date: Sep. 13, 2018

(54) MANAGING UNCERTAINTY FOR RELIABLE FLEET ASSIGNMENT ACROSS AIRCRAFT FLEET OPERATORS

(71) Applicant: Stellar Labs, Inc., Redwood City, CA (US)

(72) Inventors: Nicoleta Neagu Tchamkerten, Verrieres le Buisson (FR); Gary Waldman, Alameda, CA (US)

(21) Appl. No.: 15/909,739

(22) Filed: Mar. 1, 2018

Related U.S. Application Data
(60) Provisional application No. 62/467,006, filed on Mar. 3, 2017.

(51) Int. Cl. G08G 5/00; G06Q 10/06

(52) U.S. Cl. CPC G08G 5/0034; G06Q 10/06315; G08G 5/0043

(57) ABSTRACT

A reliability data is stored for each of at least a first subset of a plurality of aircraft comprising a fleet of aircraft. A plurality of feasible solutions to fulfill transportation requirements of a plurality of groups of one or more passengers using aircraft comprising the fleet is determined, each group having a requirement to travel starting location of that group to a destination location of that group. Based at least in part on the plurality of feasible solutions and the reliability data, a plurality of scenarios are generated, each of which would result in a delay or cancellation affecting at least a second subset of the plurality of feasible solutions. With respect to each feasible solution and for each scenario an additional cost component is computed for that feasible solution associated with occurrence of that scenario. A solution is selected from among the plurality of feasible solutions based at least in part on the additional cost component associated with occurrence of a respective scenario.

### CROSS REFERENCE TO OTHER APPLICATIONS

This application claims priority to U.S. Provisional Patent Application No. 62/467,006 entitled MANAGING UNCERTAINTY FOR RELIABLE FLEET ASSIGNMENT ACROSS AIRCRAFT FLEET OPERATORS filed Mar. 3, 2017 which is incorporated herein by reference for all purposes.

### BACKGROUND OF THE INVENTION

Assigning flights more efficiently to an aircraft fleet, improves at least one of the following: reducing economic and ecological waste, improving resource allocation, increasing operational stability, enhancing control, and increasing quality of service.

### BRIEF DESCRIPTION OF THE DRAWINGS

Various embodiments of the invention are disclosed in the following detailed description and the accompanying drawings.

FIG. 1 is a functional diagram illustrating a programmed computer/server system for fleet assignment in accordance with some embodiments.

FIG. 2 is a block diagram illustrating an embodiment of a system for fleet assignment.

FIG. 3 is a block diagram illustrating an embodiment of a fleet assignment server.

FIG. 4 is a flow chart illustrating an embodiment of a process for generating a resilient flight plan for transporting a set of customers.

FIG. 5 is a workflow illustrating an embodiment of a process for organizing a flight schedule for a group of customers.

FIG. 6 is a flow chart illustrating an embodiment of a process for generating a resilient flight plan.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Factoring for aircraft dysfunction and/or flight delay in fleet assignment and/or scheduling across an aircraft fleet is disclosed. Factoring for aircraft dysfunction and/or flight delay allows better utilization of the fleet of aircraft over time, as each element is used in a way that optimizes use over time given each aircraft has a track record that likely will be predictive of its availability over time. Factoring for aircraft dysfunction and/or flight delay also allows the improvement of reduced use of computer storage of databases related to fleet assignment as less recovery flights may need to be planned.

As referred to herein, “fleet assignment” is the problem of assigning a flight to a fleet of aircraft to minimize some objective function while satisfying certain operational constraints. In one embodiment, a fleet is homogenous and an objective function is total travel time of each aircraft, wherein the constraints include maximum flying time per day and pilot curfews. As referred to herein, a “mechanical event” is an event recorded in a log associated with an aircraft when mechanic staff need spend time with the aircraft beyond typical maintenance and/or wear-and-tear. In one embodiment, a mechanical event is associated whenever an aircraft cannot fly when it is expected to fly. For example, an engine replacement would be one of many repairs considered a mechanical event. In one embodiment, a mechanical event also includes a flight delay, a start time delay, a flight duration delay, and/or a dysfunction associated with and/or attributed to the aircraft for other reasons.

In one embodiment, aircraft fleet planning is performed over a relatively short time horizon, for example the next three days. In one embodiment, the aircraft fleet assignment problem is addressed as a global optimization problem. In one embodiment, a goal is to minimize the total travel time realized by the whole fleet, wherein the “whole fleet” may refer to variously as a single fleet and/or a plurality of separately-owned/operated fleets. In one embodiment, the problem is defined as a multi-objective optimization problem, wherein customer preferences may be considered as one of the optimization criteria.

As referred to herein, a “customer” is a customer and/or customer agent representing an end user of an aircraft flight. Typically, online and other markets permit a customer to purchase a flight on an aircraft, wherein pricing for such a trip may be based on a set of rules. As referred to herein a “trip” generally refers to a flight, trip, iternary, and/or leg of a trip, that is a segment of a trip, unless otherwise specified. This set of typical fare rules takes into consideration the costs of providing a requested service, for example a flight on a given day/time for a certain number of passengers between an originating location and a destination location. A rule-based approach may not take into account the cost that adding a proposed trip would have on other aspects of fleet operations.

In one embodiment, an initial optimal fleet assignment solution is determined based on a set of fares booked to date. As referred to herein a “fleet assignment server” is a server or servers to provide a marketplace and/or exchange to purchase air transportation via aircraft across one or more operators.

Techniques disclosed find optimization solutions for fleet assignment and scheduling problems in the air transportation business. These optimization solutions are resilient to common mechanical events such as aircraft dysfunctions and/or flight/start time delays. In one embodiment, different assumptions regarding unexpected mechanical events are considered while searching for a flight plan of a fleet.

In one embodiment, a more “resilient” flight plan is considered to be one in which an aircraft dysfunction and/or time delay has a more limited impact. A computer-implemented flight plan application may identify a resilient flight plan that performs well with respect to a range of uncertain possible conditions at the lowest additional cost to overall set of operators and relative to other flight plans. This range of uncertain possible conditions may include a combination of mechanical events associated with more than one aircraft in the associated fleet.

Mechanical event information for a given aircraft may come from a variety of sources, for example governmental records, FAA records, and mechanical event logs. In one embodiment, for newer aircraft with fewer statistics, theoretical modeling may be used to provide mechanical event information. In one embodiment, mechanical event information may be expressed as statistics, for example as “an average of one mechanical event every thirty flights”.

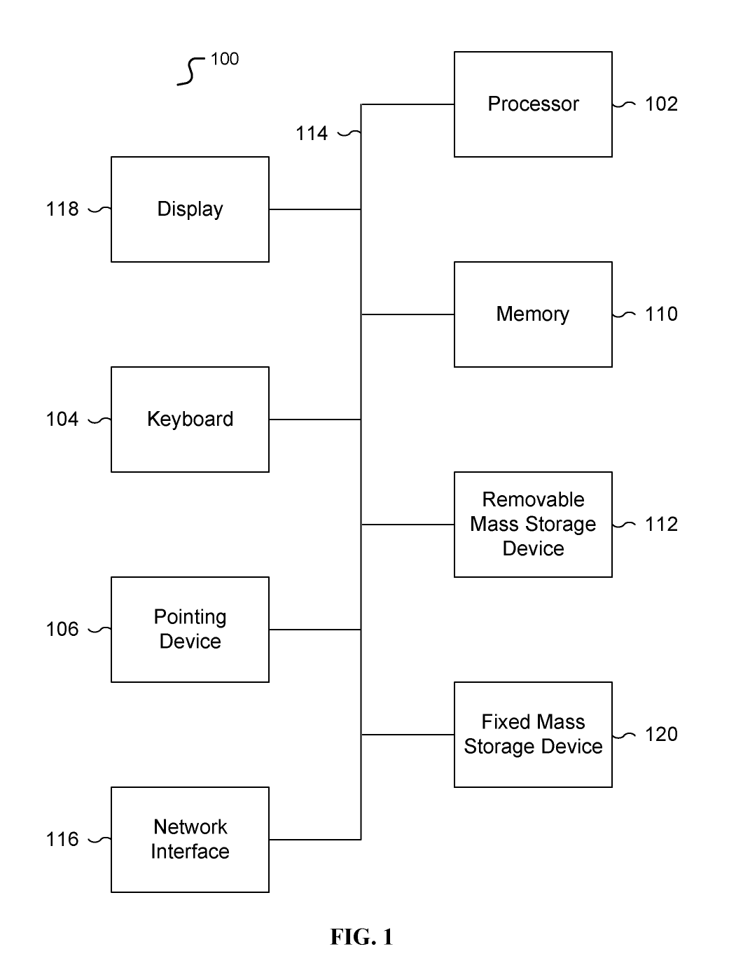

FIG. 1 is a functional diagram illustrating a programmed computer/server system for fleet assignment in accordance with some embodiments. As shown, FIG. 1 provides a functional diagram of a general purpose computer system programmed to provide fleet assignment in accordance with some embodiments. As will be apparent, other computer system architectures and configurations may be used for fleet assignment.

Computer system 100, which includes various subsystems as described below, includes at least one microprocessor subsystem, also referred to as a processor or a central processing unit (“CPU”) 102. For example, processor 102 may be implemented by a single-chip processor or by multiple cores and/or processors or by virtual processors. In some embodiments, processor 102 is a general purpose digital processor that controls the operation of the computer system 100. Using instructions retrieved from memory 110, the processor 102 controls the reception and manipulation of input data, and the output of data on output devices, for example network interface 116 or storage 120.

Processor 102 is coupled bi-directionally with memory 110, which may include a first primary storage, typically a random-access memory (“RAM”), and a second primary storage area, typically a read-only memory (“ROM”). As is well known in the art, primary storage may be used as a general storage area and as scratch-pad memory, and may also be used to store input data and processed data. Primary storage may also store programming instructions and data, in the form of data objects and text objects, in addition to other data and instructions for processes operating on processor 102. Also as well known in the art, primary storage typically includes basic operating instructions, program code, data and objects used by the processor 102 to perform its functions, for example programmed instructions. For example, primary storage devices 110 may include any suitable computer-readable storage media, described below, depending on whether, for example, data access needs to be bi-directional or uni-directional. For example, processor 102 may also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read only) to processor 102. For example, storage 112 may also include computer-readable media such as flash memory, portable mass storage devices, holographic storage devices, magnetic devices, magneto-optical devices, optical devices, and other storage devices. A fixed mass storage 120 may also, for example, provide additional data storage capacity. The most common example of mass storage 120 is an eMMC device. In one embodiment, mass storage 120 is a solid-state drive connected by a bus 114. Mass storage 112, 120 generally store additional programming instructions, data, and the like that typically are not in active use by the processor 102. It will be appreciated that the information retained within mass storage 112, 120 may be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a network interface 116, a keyboard and/or pointing device 104, as well as an auxiliary input/output device 106 interface, a sound card, microphone speakers, and other subsystems as needed. For example, the pointing device 104 can be a mouse, stylus, track ball, touch display, and/or tablet, and is useful for interacting with a graphical user interface.

The communication interface 116 allows processor 102 to be coupled to another computer, computer network, or telecommunications network using a network connection as shown. For example, through the communication interface 116, the processor 102 may receive information, for example data objects or program instructions, from another network, or output information to another network in the course of performing method/process steps. Information, often represented as a sequence of instructions to be executed on a processor, may be received from and outputted to another network. An interface card or similar device and appropriate software implemented by, for example executed/performed on, processor 102 may be used to connect the computer system 100 to an external network and transfer data according to standard protocols. For example, various process embodiments disclosed herein may be executed on processor 102, or may be performed across a network such as the Internet, intranet networks, or local area networks, in conjunction with a remote processor that shares a portion of the processing. As referred to herein “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous, heterogeneous systems and/or groups of systems together. Additional mass storage devices, not shown, may also be connected to processor 102 through communication interface 116.

In addition, various embodiments disclosed herein further relate to computer storage products with a computer readable medium that includes program code for performing various computer-implemented operations. The computer-readable medium is any data storage device that may store data which may thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC” s), programmable logic devices (“PLD” s), and ROM and RAM devices. Examples of program code include both machine code, as produced, for example, by a compiler, or files containing higher level code, for example a script, that may be executed using an interpreter.

The computer/server system shown in FIG. 1 is but an example of a computer system suitable for use with the various embodiments disclosed herein. Other computer systems suitable for such use may include additional or fewer subsystems. In addition, bus 114 is illustrative of any interconnection scheme serving to link the subsystems. Other computer architectures having different configurations of subsystems may also be utilized, including virtual servers.

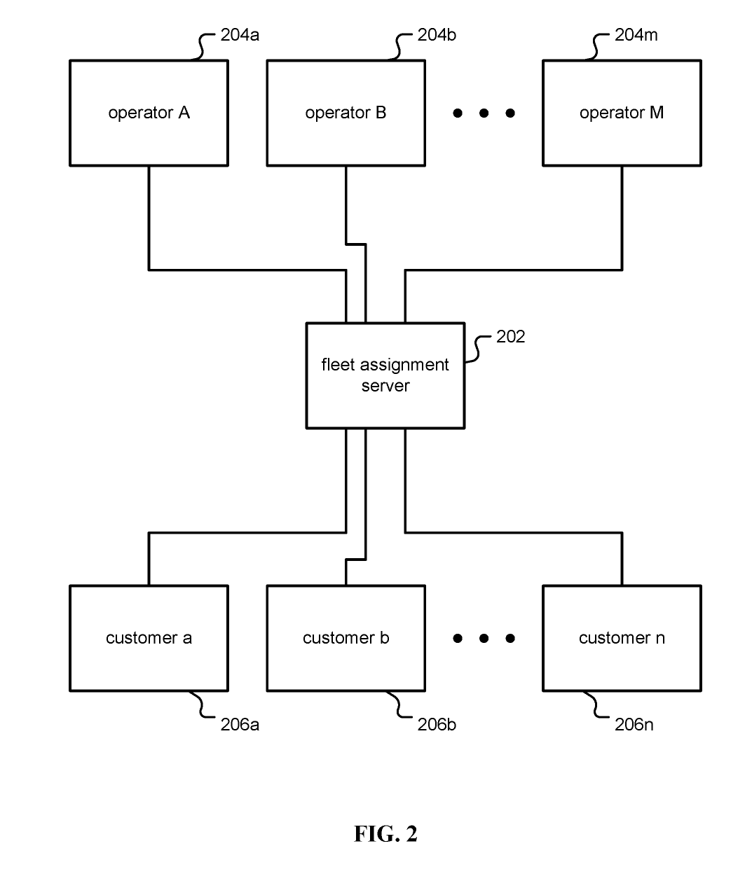

FIG. 2 is a block diagram illustrating an embodiment of a system for fleet assignment. In one embodiment, the fleet assignment server (202) in FIG. 2 includes the server of FIG. 1.

The fleet assignment server (202) is coupled to one or more customers (206) via a web-based and/or mobile app-based interface, for example as shown in FIG. 2 with customer a (206a), customer b (206b), and so on up to customer n (206n). As referred to herein, an “operator” is any owner and/or operator of one or more aircrafts and/or aircraft fleets that may charter one or more flights for a customer. One or more operators (204) are coupled to the fleet assignment server (202) and may indicate available inventory via a web or other interface, for example as shown in FIG. 2 with operator A (204a), operator B (204b), and so on up to operator M (204m).

In one embodiment, the fleet assignment server (202) accepts requests from a customer (206) for a trip and determines a solution based on availability as indicated by one or more operators (204). Prior to a request, an existing optimal fleet assignment solution across fares and operators (204) may already be determined.

In one embodiment, for a request from a customer (206) leading to an incremental trip or any trip added to an existing optimal solution, a cost component associated with a “disruption” to the previously-determined optimal fleet assignment plan is determined by fleet assignment server (202) or another server. This disruption cost may be directly and/or indirectly reflected in a price quoted to the requesting customer (206) for the requested trip.

In one embodiment, another input to the fleet server (202) is mechanical event information. This mechanical event information is used to improve resilience of the optimization solutions.

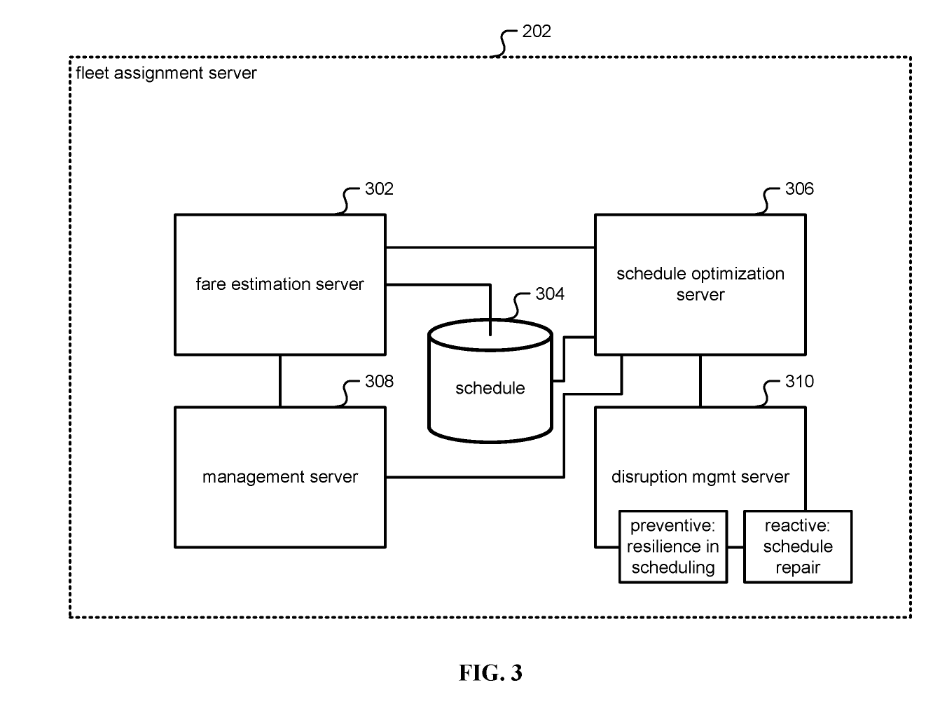

FIG. 3 is a block diagram illustrating an embodiment of a fleet assignment server. In one embodiment, the server of FIG. 3 is included as server (202) of FIG. 2.

As shown in FIG. 3, fleet assignment server (202) comprises one or more servers, wherein a server may include a physical server, virtual server, cloud based server, server module, server engine, and/or an application/module/engine running on one or more processors/cores/threads.

Fare estimation server (302) establishes pricing for a trip. An objective of the fare estimation server (302) is to effectively estimate a fare price based on given pricing rules and disruption cost. Fare estimation server (302) may use pricing rules and/or fare rules to establish pricing without disruption analysis. When a customer (206) orders a new trip, fare estimation server (302) is responsible to determine a price for the customer (206) and process/confirm the transaction. Fare estimation server (302) also receives and factors in a disruption cost, if any, from the schedule optimization server (306). Fare estimation server (302) also may indicate when a proposed leg and/or trip is booked to the fleet schedule store (304) for the current fleet assignment plan and/or fleet schedule across one or more operators (204).

Schedule optimization server (306) determines a fleet schedule for fleet schedule store (304). An objective of schedule optimization server (306) is to develop an optimal schedule amongst the network of operators (204) based on at least one of the following: environmental variables, available resources, customer demand, available capacity, and operational imperatives. In one embodiment, schedule optimization server (306) may compute in real-time or not in real-time the disruption cost component.

When a customer (206) orders a new trip, the new client order may trigger schedule optimization server (306) to compute a disruption cost to be transmitted to fare estimation server (302) for a real-time fare estimate/quote to fulfill the new client order. In one embodiment, fleet assignment in the schedule optimization server (306) comprises identifying schedule optimized for the total travel time and/or the cost to one or more operators. In one embodiment, fleet assignment in the schedule optimization server (306) comprises fleet and leg scheduling, preferences, and/or uncertainty management. In one embodiment, schedule optimization server (306) is responsible not only for fleet assignment but also crew scheduling and/or forecasting. In one embodiment, this forecasting includes forecasting at least one of the following: environment, resources, customer demand, price optimization, capacity, and operators. In one embodiment, crew scheduling comprises crew planning/rostering and/or uncertainty management.

Both fare estimation server (302) and schedule optimization server (306) are coupled to management server (308), wherein the management server (308) may have an objective to set fares to maximize revenue across customer segments and to effectively compete in the market.

A disruption management server (310) is coupled to the schedule optimization server (306) to deal with uncertainty occurring in aircraft operations. In one embodiment, disruption management server (310) may generate realistic future scenarios involving mechanical events such as aircraft dysfunction and/or aircraft delays at least in part based on historical disruption data, and/or comprise a scenarios-based approach/method to dealing with uncertainty.

In one embodiment, fleet assignment server (202), fare estimation server (302), schedule optimization server (306), and/or disruption management server (310) use operations research models to generate more optimal solutions by at least one of the following: conducting and coordinating the operations, improving efficiency, and increasing productivity of economies. The server(s) may include operations research for planning comprising: schedule planning; crew planning and rostering; flight assignment and optimization; and/or resource optimization. The server(s) may include operations research for execution comprising: flight path optimization; disruption management; and/or aircraft and crew recovering. The server(s) may include operations research for marketing comprising: demand forecast; revenue management; and/or price optimization.

In one embodiment, fleet assignment server (202), fare estimation server (302), schedule optimization server (306), and/or disruption management server (310) use operations planning for various stages of planning. For monthly and/or long-term planning, operations planning includes at least one of the following: a market/customers to serve; a basic schedule structure; partnerships; routes and frequencies; and initial aircraft/crew assignments. For weekly and/or medium-term planning, operations planning includes at least one of the following: fleet assignment; crew assignment/rostering; and revenue/price optimization. For daily and/or operations/short-term planning, operations planning includes at least one of the following: short-term re-fleeting; recover aircraft/schedule from disruptions; and aircraft/crew recovery from disruptions.

In one embodiment, fleet assignment server (202), fare estimation server (302), schedule optimization server (306), and/or disruption management server (310) use a homogenous and/or heterogenous fleet assignment management (“FAM”) approach that comprises a model based at least in part on: fleet characteristics, customer demands, for example with respect to legs/trips; a distance matrix; and/or duty constraints. An objective of FAM is to minimize the total flight time for one or more operators using a local search approach. Integrating resilience into FAM is disclosed.

In the airline industry traditionally operations research techniques and tools may be used for the planning and scheduling of resources. Optimization-based decision support systems have proven to be efficient and cost-saving for the scheduling of aircraft and crew and short term re-scheduling problems, where modifications to the initial plans are required before the final schedules can be executed. However, on the day of operation carefully planned crew and aircraft schedules can become infeasible due to external disruptions and internal failures. To date, no scheduling tools have been able to cope with the complexity of re-scheduling all airline operations at the same time during disruptions.

In one embodiment, an aircraft fleet schedule optimization platform (202) in a first stage generates a schedule from a given set of orders that minimizes operational costs (306) of a fleet, for example a cross operator floating fleet, and, in particular, the number of empty legs. In a second stage, the optimized schedule may then be used to obtain the operational cost (310), referred herein as the “disruption cost,” of integrating a new order into the schedule. This operational cost is then used in conjunction with a pricing module (302) to generate a live leg price for the new order. In a third stage, uncertain events such as disruptive events that may occur, such as mechanical events like aircraft dysfunction and/or delay are taken into consideration by a disruption management module (310). An optimized schedule is refined in two ways: preventively, by generating resilient schedules, and reactively, by correcting schedules which were not resilient enough to the mechanical events. This aircraft fleet schedule optimization approach thus allows one to search proactively for flight scheduling solutions that are more resilient to mechanical events occurring in aviation operations.

A person having ordinary skill in the art understands that achieving robust optimization of fleet assignment and scheduling in the context of on demand private aviation may also without limitation be applied to commercial aviation and aviation in general.

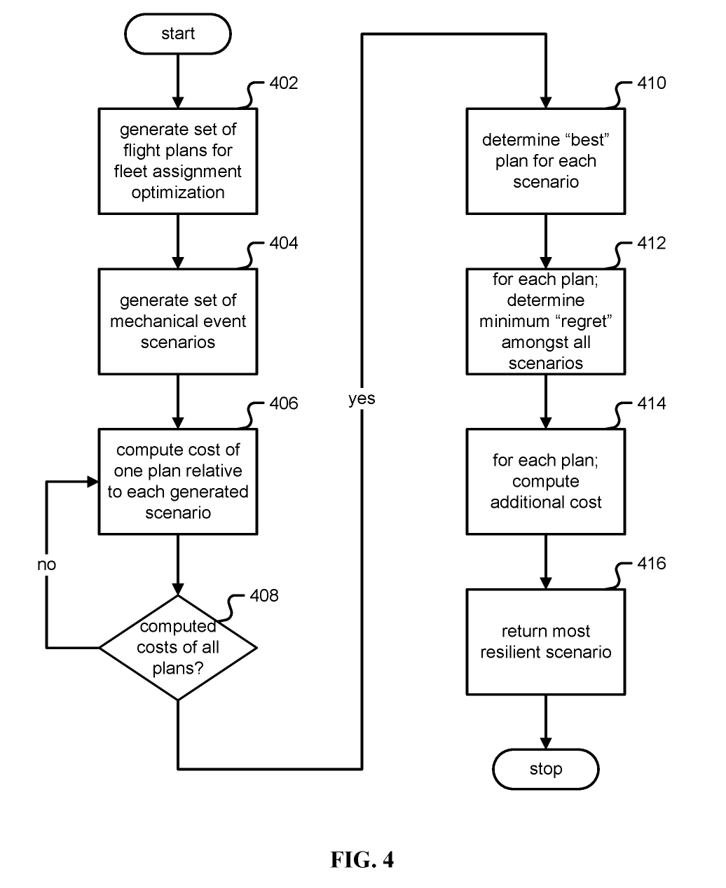

FIG. 4 is a flow chart illustrating an embodiment of a process for generating a resilient flight plan for transporting a set of customers. In step 402, a set of flight plans are generated for fleet assignment optimization, for example and without limitation using the techniques described in U.S. patent application Ser. No. 15/449,822 entitled FLEET OPTIMIZATION ACROSS ONE OR MORE PRIVATE AIRCRAFT FLEETS filed Mar. 3, 2017 which is incorporated herein by reference for all purposes.

In step 404, a set of mechanical event scenarios are generated and/or anticipated. Each scenario specifies a period during which one or more aircraft are presumed to be nonoperational, and/or have start time or fly time delay. In one embodiment, mechanical event statistics are correlated with the likelihood of a specific mechanical event scenario, for example for a specified aircraft that is relatively unreliable at one mechanical event per 30 flights, the likelihood of a mechanical event scenario involving that specified aircraft is increased.

As shown between steps 406 and 408, a set of flight plans may be generated for each scenario, such that each plan specifies an aircraft's schedule for transporting a set of customers and computing a cost for each plan relative to each generated scenario; the process is iterated over all plans. In step 410, a “best” plan for each scenario is determined, wherein “best” may be specified strategically for example the lowest cost plan. In step 412, the cost of each “best” scenario plan may be evaluated according to a specified evaluation method to compute a resilience measure which is referred to herein as scenario ‘regret’. Thus for each plan the scenario with minimum regret is determined. In a step 414 an additional cost component is computed for each plan cost component for that feasible solution associated with occurrence of that scenario. In step 416 the robust flying schedule returned is a plan having a best determined cost versus resilience measure tradeoff, relative to other plans in the generated set of plans. In one embodiment, the returned plan is the plan with the lowest sum of resilience measures over all scenarios.

In one embodiment, a flight scheduling application is used on server (202) to generate a robust flight schedule for transporting a set of customers. The operation itself may generally include generating one or more mechanical event scenarios. Each mechanical event scenario specifies a period during which one or aircrafts is presumed to be non-operational and/or delayed. This operation may further include generating a set of flight plans. Each plan specifies a delivery schedule for transporting the set of customers and determining a cost for each plan relative to each generated scenario. This operation may further include evaluating the cost of each plan according to a specified evaluation operation to compute a resilience measure for each plan and returning, as the resilient flight plan, a solution having a best determined cost versus a resilience measure tradeoff, relative to other flight plans in the generated set of plans.

In one embodiment, a flight scheduling application is provided, which when executed performs an operation for generating a robust flight plan for the transportation of a set of customers. The operation itself may generally include generating one or more mechanical event scenarios. Each mechanical event scenario specifies a period during which one or more aircrafts is presumed to be non-operational. This operation may further include generating a set of flight plans. Each plan specifies a delivery schedule for the transportation of a set of customers and determining a cost for each solution relative to each generated scenario. This operation may further include evaluating the cost of each plan according to a specified evaluation operation to compute a resilience measure for each plan and returning, as the resilient delivery schedule, a plan having a best determined cost versus a resilience measure tradeoff, relative to other plans in the generated set of plans.

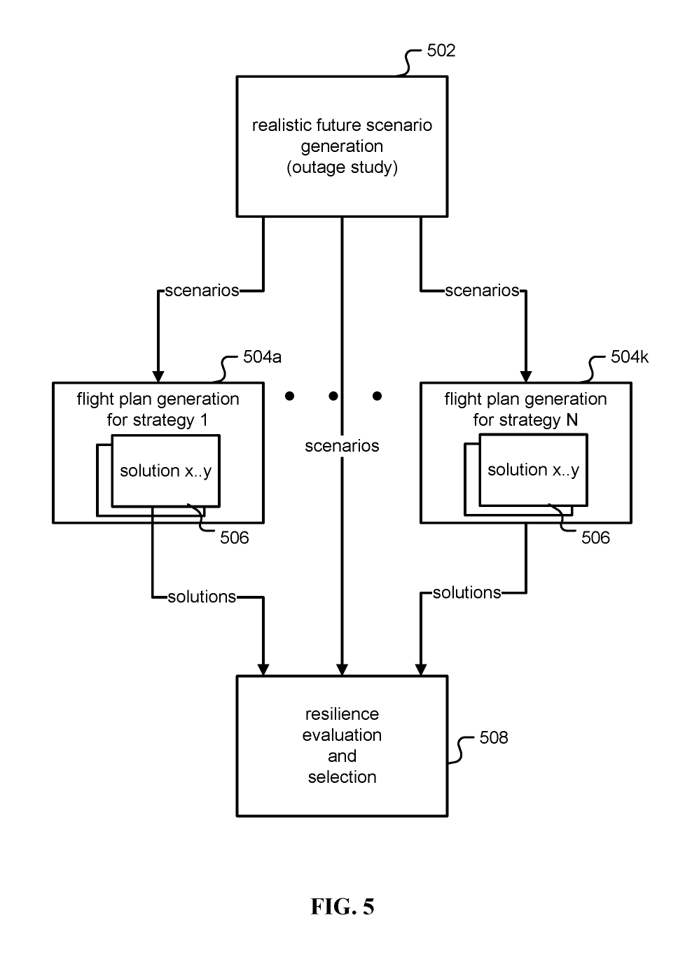

FIG. 5 is a workflow illustrating an embodiment of a process for organizing a flight schedule for a group of customers. Realistic future scenarios are generated (502) to represent possible mechanical events. As referred to herein, ‘realistic’ may be assessed at least in part on the probability and/or statistics of mechanical event information gathered and/or weighted appropriately to represent a more likely set of scenarios of mechanical of events.

These resulting scenarios are passed to solution generation strategies (504a . . . 504k), each of which generate a set of solutions (506) such that each solution is feasible, that is a solution satisfies flying requirements, when applied to any of the realistic mechanical event scenarios.

Lastly, the costs of each solution applied to each scenario is computed, that is the cost of the solution without mechanical event is compared to the cost of the solution with the mechanical event for a given scenario.

In one embodiment, a min max regret and/or min max deviation evaluation method (508) is used to compute the resilience of each solution. In one embodiment, the solution with the best cost versus robustness tradeoff is selected as the most resilient. An example of how the min max regret approached is used in selecting a reliable solution is presented in Table 1. We consider a set of scenarios S={M,N,O,P} and a set of solutions A={0,1,2,3}. Fₛ(x) represents the cost of solution x on scenario s, and \dot{F}ₛ represents the best known cost on scenario s.

The min-max regret is defined as minimizing the worst case deviation from optimality among all feasible scenarios: z_{D}=min_{x∈A}(max_{s∈S}(Fₛ(X)−\dot{F}ₛ)). The maximum deviation is calculated for each solution relative to the given scenarios.

TABLE 1
Example of realistic scenarios and feasible solutions.

| | Costs | | | |
|---|---|---|---|---|
| | Solution 0 | Solution 1 | Solution 2 | Solution 3 |
| Scenario M | 1 | 6 | 1 | 9 |
| Scenario N | 12 | 8 | 26 | 14 |
| Scenario O | 21 | 15 | 5 | 22 |
| Scenario P | 15 | 8 | 2 | 16 |

Thus, the lowest cost for each scenario in Table 1 is shown in Table 2:

TABLE 2
Solution with lowest cost for a given Scenario.

| | Lowest Cost |
|---|---|
| Scenario M | 1 |
| Scenario N | 8 |
| Scenario O | 5 |
| Scenario P | 2 |

Correspondingly, the deviation table Table 3 shows the deviation for each solution from the lowest cost across any solution in Table 2.

TABLE 3
Deviation Table

| | Deviation | | | |
|---|---|---|---|---|
| | Solution 0 | Solution 1 | Solution 2 | Solution 3 |
| Scenario M | 0 | 5 | 0 | 8 |
| Scenario N | 4 | 0 | 18 | 6 |
| Scenario O | 16 | 10 | 0 | 17 |
| Scenario P | 13 | 6 | 0 | 14 |

Finally for each solution, the maximum deviation for each scenario is computed in Table 4.

TABLE 4
Maximum deviation for each Solution for any Scenario.

| | Costs | | | |
|---|---|---|---|---|
| | Solution 0 | Solution 1 | Solution 2 | Solution 3 |
| Maximum | 16 | 10 | 18 | 17 |
| Deviation for | | | | |
| any Scenario | | | | |

For the example of using a min max regret, Solution 1 thus has the minimum maximum regret (deviation) as 10 is lower than 16, 17, and 18. Thus for a min max regret, Solution 1 is selected, as it has the lowest maximum deviation from optimality across all feasible scenarios.

One example of why a min max regret solution works well is a hypothetical scenario where two trips need to leave from San Francisco, one to Maui five hour away, and another to Los Angeles one hour away. Two aircraft are available, one older lighter aircraft that has a poor FAA record for mechanical events at one event per thirty flights, and another newer but heavier aircraft that has an excellent FAA record for mechanical events at one event per three hundred flights. Even though it is more expensive to run the newer aircraft to Maui, a min max regret solution finds that the scenario of an older aircraft flying to Maui and breaking down presents such a high recovery cost and instead schedules the newer more expensive aircraft to Maui. A recovery cost for Maui involves flying a second aircraft later to Maui, which is five hours of recovery cost in forward travel.

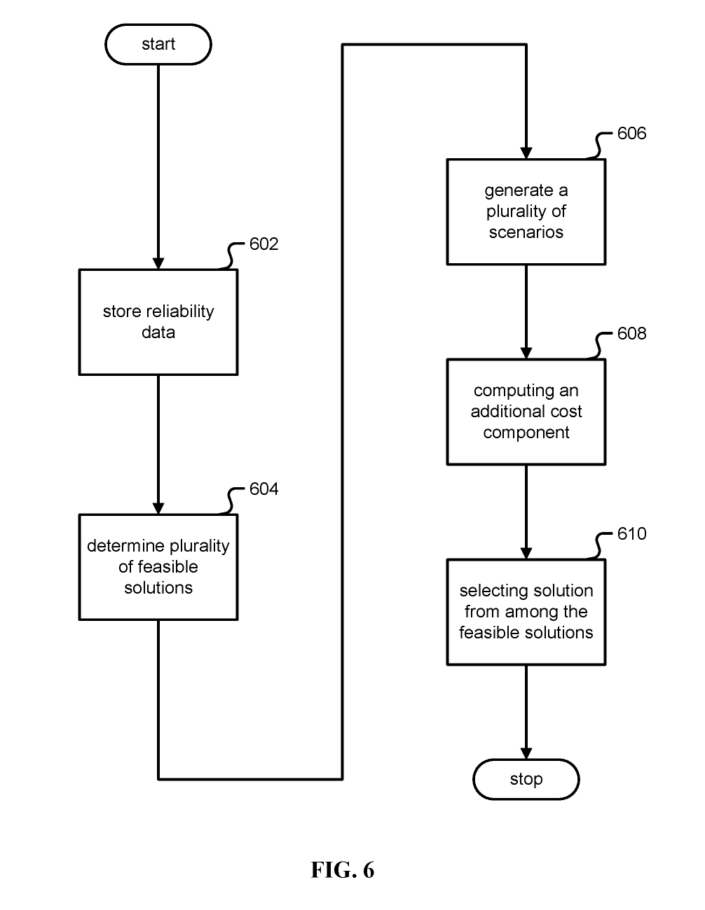

FIG. 6 is a flow chart illustrating an embodiment of a process for generating a resilient flight plan. In one embodiment, the flow chart of FIG. 6 is carried out by fleet assignment server (202) of FIG. 2.

In step 602, reliability data for each of at least a first subset of a plurality of aircraft comprising a fleet of aircraft is received and/or stored. In one embodiment, the reliability data is used to determine feasible solutions. In one embodiment, the reliability data is used to determine realistic scenarios. In one embodiment, the reliability data includes mechanical event or other equipment failure data. In one embodiment, the reliability data includes mechanical event information, wherein a mechanical event includes an event associated with at least one of the following: aircraft dysfunction, aircraft failure, and flight delay. In one embodiment, the reliability data includes mechanical event information from an FAA record. In one embodiment, the aircraft are associated with at least one of the following: a private aviation company, and a commercial aviation company.

In one embodiment, the fleet of aircraft includes aircraft across a plurality of operators. In one embodiment, the fleet of aircraft includes aircraft across a plurality of operators and wherein the processor is further configured to aggregate a plurality of reliability data across the plurality of operators. In one embodiment, the fleet of aircraft includes aircraft across a plurality of operators and wherein the processor is further configured to normalize a plurality of reliability data across the plurality of operators.

In step 604, a plurality of feasible solutions to fulfill transportation requirements of a plurality of groups of one or more passengers using aircraft comprising the fleet is determined. In one embodiment, each group of the plurality of groups has a requirement to travel from a starting location of that group to a destination location of that group. In one embodiment, a specific feasible solution is determined based on a starting location and passenger capacity of each aircraft.

In step 606, a plurality of scenarios each of which would result in a delay or cancellation affecting at least a second subset of the plurality of feasible solutions is generated based at least in part on the plurality of feasible solutions and the reliability data. In step 608, an additional cost component for that feasible solution associated with occurrence of that scenario is computed with respect to each feasible solution and for each scenario.

In step 610, a solution is selected from among the plurality of feasible solutions based at least in part on the additional cost component associated with occurrence of a respective scenario. In one embodiment, the selected solution is selected using a cost function to attempt to minimize cost. In one embodiment, the selected solution is selected to minimize aggregated difference across scenarios from minimum cost within each scenario. In one embodiment, the selected solution is selected to minimize regret. In one embodiment, the selected solution is selected to be a min max regret solution.

In one embodiment, the selected solution is selected based at least in part on: computing a cost associated with each scenario for each solution; determining a smallest cost for a given scenario; computing for each solution a solution difference between its cost for the given scenario and the lowest cost among solutions for the given scenario; summing each solution difference across scenarios into a solution sum; and picking the specific feasible solution as that with a lowest solution sum.

In one embodiment, an additional step (not shown) includes resolving a disruption based on a request from a customer leading to an incremental trip or any trip added to an existing optimal solution.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory or other data storage device configured to store a reliability data for each of at least a first subset of a plurality of aircraft comprising a fleet of aircraft; and
a processor coupled to the memory and configured to:
determine a plurality of feasible solutions to fulfill transportation requirements of a plurality of groups of one or more passengers using aircraft comprising the fleet of aircraft, each group having a requirement to travel starting location of that group to a destination location of that group;
generate, based at least in part on the plurality of feasible solutions and the reliability data, a plurality of scenarios each of which would result in a delay or cancellation affecting at least a second subset of the plurality of feasible solutions;
compute with respect to each feasible solution and for each scenario an additional cost component for that feasible solution associated with occurrence of that scenario; and
select a selected solution from among the plurality of feasible solutions based at least in part on the additional cost component associated with occurrence of a respective scenario.

2. The system of claim 1, wherein the reliability data is used to determine feasible solutions.

3. The system of claim 1, wherein the reliability data is used to determine realistic scenarios.

4. The system of claim 1, wherein the reliability data includes mechanical event or other equipment failure data.

5. The system of claim 1, wherein the reliability data includes mechanical event information, wherein a mechanical event includes an event associated with at least one of the following: aircraft dysfunction, aircraft failure, and flight delay.

6. The system of claim 1, wherein the reliability data includes mechanical event information from an FAA record.

7. The system of claim 1, wherein the fleet of aircraft includes aircraft across a plurality of operators.

8. The system of claim 1, wherein the fleet of aircraft includes aircraft across a plurality of operators and wherein the processor is further configured to aggregate a plurality of reliability data across the plurality of operators.

9. The system of claim 1, wherein the fleet of aircraft includes aircraft across a plurality of operators and wherein the processor is further configured to normalize a plurality of reliability data across the plurality of operators.

10. The system of claim 1, further comprising a communication interface coupled to the memory, wherein the communication interface is configured to receive the reliability data.

11. The system of claim 1, wherein a specific feasible solution is determined based on a starting location and passenger capacity of each aircraft.

12. The system of claim 1, wherein a specific feasible solution is determined based on a starting location and passenger capacity of each aircraft, and wherein the selected solution is selected using a cost function to attempt to minimize cost.

13. The system of claim 1, wherein a specific feasible solution is determined based on a starting location and passenger capacity of each aircraft, and wherein the selected solution is selected to minimize aggregated difference across scenarios from minimum cost within each scenario.

14. The system of claim 1, wherein a specific feasible solution is determined based on a starting location and passenger capacity of each aircraft, and wherein the selected solution is selected to minimize regret.

15. The system of claim 1, wherein a specific feasible solution is determined based on a starting location and passenger capacity of each aircraft, and wherein the selected solution is selected to be a min max regret solution.

16. The system of claim 1, wherein the aircraft are associated with at least one of the following: a private aviation company, and a commercial aviation company.

17. The system of claim 1, wherein the processor is further configured to resolve a disruption based on a request from a customer leading to an incremental trip or any trip added to an existing optimal solution.

18. The system of claim 1, wherein a specific feasible solution is determined based on a starting location and passenger capacity of each aircraft, and wherein the selected solution is selected based at least in part on:
computing a cost associated with each scenario for each solution;
determining a smallest cost for a given scenario;
computing for each solution a solution difference between its cost for the given scenario and the lowest cost among solutions for the given scenario;
summing each solution difference across scenarios into a solution sum; and
picking the specific feasible solution as that with a lowest solution sum.

19. A method, comprising:
storing a reliability data for each of at least a first subset of a plurality of aircraft comprising a fleet of aircraft;
determining a plurality of feasible solutions to fulfill transportation requirements of a plurality of groups of one or more passengers using aircraft comprising the fleet of aircraft, each group having a requirement to travel starting location of that group to a destination location of that group;
generating, based at least in part on the plurality of feasible solutions and the reliability data, a plurality of scenarios each of which would result in a delay or cancellation affecting at least a second subset of the plurality of feasible solutions;
computing with respect to each feasible solution and for each scenario an additional cost component for that feasible solution associated with occurrence of that scenario; and
selecting a selected solution from among the plurality of feasible solutions based at least in part on the additional cost component associated with occurrence of a respective scenario.

20. A computer program product, the computer program product being embodied in a non-transitory computer readable storage medium and comprising computer instructions for:
storing a reliability data for each of at least a first subset of a plurality of aircraft comprising a fleet of aircraft;
determining a plurality of feasible solutions to fulfill transportation requirements of a plurality of groups of one or more passengers using aircraft comprising the fleet of aircraft, each group having a requirement to travel starting location of that group to a destination location of that group;
generating, based at least in part on the plurality of feasible solutions and the reliability data, a plurality of scenarios each of which would result in a delay or cancellation affecting at least a second subset of the plurality of feasible solutions;
computing with respect to each feasible solution and for each scenario an additional cost component for that feasible solution associated with occurrence of that scenario; and
selecting a selected solution from among the plurality of feasible solutions based at least in part on the additional cost component associated with occurrence of a respective scenario.
